(19) United States
(12) Patent Application Publication
(10) Pub. No.: US 2010/0144385 A1
(43) Pub. Date: Jun. 10, 2010

(54) TWO-MODE MOBILE TELEPHONE TERMINAL CAPABLE OF AUTOMATICALLY AND COMPLETELY DISABLING THE RADIO TRANSMISSION OF ITS INTERFACE INTENDED FOR A WIRELESS GLOBAL TELECOMMUNICATIONS NETWORK

(76) Inventor: Raymond Gass, Bolsenheim (FR)

Correspondence Address: HARNESS, DICKEY & PIERCE, P.L.C., P.O. BOX 8910, RESTON, VA, 20195, US

(21) Appl. No.: 12/450,077

(22) PCT Filed: Mar. 4, 2008
(86) PCT No.: PCT/EP2008/052620

§ 371 Date: Feb. 4, 2010

(30) Foreign Application Priority Data
Mar. 15, 2007 (FR) 07/53844

(51) Int. Cl. H04W 88/06; H04M 1/00

(52) U.S. Cl. 455/552.1

(57) ABSTRACT

This two-mode mobile telephone terminal (T) comprises a first interface (GI) intended to connect it to a wireless global telecommunications network (PLMN), a second interface (WI) intended to connect it to a wireless local area telecommunications network (WLAN), and a control unit (CU) for receiving, from the second interface (WI), a signal (S1) indicating that that terminal is connected to a wireless local area telecommunications network (WLAN), and then to send to the first interface (GI) a control signal (S2) capable of completely disabling the radio transmission of that first interface (GI).

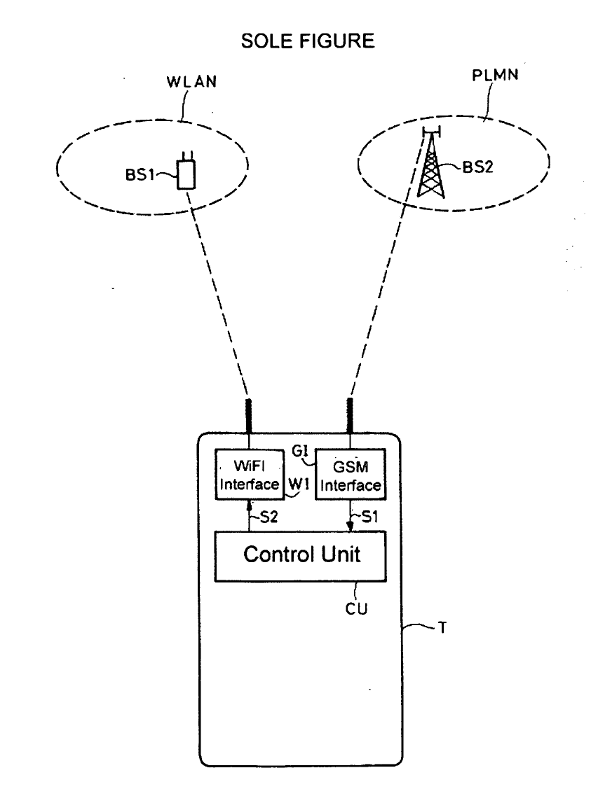

### CROSS-REFERENCE TO RELATED APPLICATIONS

This is a National Phase of International Application No. PCT/EP2008/052620, filed Mar. 4, 2008 and claims priority to French Application No. 0753844, filed Mar. 15, 2007, the contents all of which are incorporated herein by reference in their entirety.

The invention pertains to a “two-mode” mobile telephone terminal, so called because it can alternatively function in two wireless telecommunications networks: a wireless global telecommunications network, such as a GSM network, and a wireless local area telecommunications network, such as a WiFi or Bluetooth network, for example.

A two-mode mobile telephone terminal has two radio interfaces, respectively enabling this terminal to respectively connect to a wireless global telecommunications network, and/or to a wireless local area telecommunications network, the latter network being generally incorporated into a private network: a corporate network, a hospital's network, an airport's network, etc. The global network offers coverage on a national level, but communications are costly. The local area network offers more restricted coverage, included within the previous coverage, but voice over Internet protocol (VoIP) type calls are inexpensive. The use of this local area network must be preferred for telephone communications, due to its low cost. Methods are known which make it possible to automatically transfer telephone communication from a wireless global telecommunications network to a wireless local area telecommunications network, and vice versa, when the mobile two-mode terminal enters or exits the local area network's radio coverage area.

The invention pertains to a two-mode terminal which is more particularly suited for use in hospitals. In general, the use of mobile telephone terminals capable of connecting to a wireless global telecommunications network is prohibited in hospitals, because the radiofrequency radiation from these devices may have enough power to disrupt medical electronic devices. On the other hand, the use of mobile telephone terminals capable of connecting to a wireless local area telecommunications network is permitted, because the radio-frequency radiation of these devices has a much lower power.

Some of a hospital's employees may have two-mode mobile telephone terminals. These employees use a wireless global telecommunications network when they are outside the hospital, such as when visiting patients, and they use a wireless local area telecommunications network when they are inside the hospital.

In order to avoid any radiofrequency transmissions by the radio interface intended for the wireless global telecommunications network, it is necessary to completely disable this interface: If it is merely placed in standby mode, it occasionally transmits signaling data, despite the absence of telephone communication. This is not permissible in a hospital. In a conventional two-mode terminal, this complete disabling operation is performed manually by the user every time that he enters a hospital's premises. It is desirable to automate this disabling operation for hospital employees who use a two-mode terminal.

Methods are known which make it possible to automatically transfer telephone communication from a wireless global telecommunications network to a wireless local area telecommunications network, and vice versa, when the mobile two-mode terminal enters or exits the local area network's radio coverage area. The drawback of these methods is that they do not completely disable the radio interface intended for the wireless global telecommunications network. This interface remains in standby mode, and as result it occasionally transmits signaling data, which is not permissible in a hospital.

The document US 2005/0107077 describes a station which may particularly be installed in a hospital, and which comprises means for establishing a connection, such as a WiFi connection for example, with a two-mode WiFi-GSM (for example) terminal, in order to send it the order to completely disable the radio interface used to connect it to the wireless global telecommunications network, i.e. the GSM interface. The drawback of this notification is that requires a modification to the local area network in question, which leads to installation costs.

The purpose of the invention is to disclose a terminal which makes it possible to completely and automatically disable its radio interface intended for the wireless global telecommunications network, without requiring additional equipment in the local area network.

The object of the invention is a two-mode telephone terminal, comprising a first interface intended to connect it to a wireless global telecommunications network and a second interface intended to connect it to a wireless local area telecommunications network, characterized in that it comprises control means for receiving a signal from the second interface indicating that this terminal is connected to a wireless local area telecommunications network, and then sending to the first interface a control signal capable of completely disabling the radio transmission of that first interface.

The terminal thereby characterized makes it possible to completely and automatically disable its radio interface intended for the wireless global telecommunications interface, without requiring additional equipment in the local area network, because it comprises within itself means for controlling the disabling of the radio transmission of its radio interface intended for the wireless global telecommunications network.

The invention will be better understood and other characteristics will appear with the help of the description below and the accompanying sole figure. This figure depicts an example embodiment T of the inventive terminal, and depicts its operation at a time when it enters the radio coverage area of a wireless local area telecommunications network, WLAN, such as a WiFi network, even though it is also within the radio coverage area of a wireless global telecommunications network, PLMN, such as a GSM network.

This two-mode mobile telephone terminal T comprises:
A GSM interface Gl.
A WiFi interface WI.
A control unit CU connected to the interfaces WI and GI.

Whenever the terminal T enters the radio coverage area of the wireless local area network WLAN, it is recognized as having the right to access that WLAN network, and it connects to that WLAN network, via a radio access point BS1, in a conventional manner. The interface WI then sends to the control unit CU a signal S1 indicating that this terminal T is connected to a local area telecommunications network. The control unit CU then sends the interface GI a control signal S2 capable of completely disabling the radio transmission of that interface GI.

Conversely, when the terminal T exits from the radio coverage area of the wireless local area network WLAN, the interface WI stops sending the control unit CU the signal S1 indicating that this terminal T is connected to a local area telecommunication network. The control unit CU then stops sending the interface GI a control signal S2 capable of completely disabling the radio transmission of that interface GI. The interface GI may then transmit radio signals for connecting the terminal T to the PLMN network, in a conventional manner.

Naturally, the scope of the invention is not limited to GSM/Wifi two-mode terminals. It may be adapted to global networks of other types, such as UMTS, and to local area networks of other types, such as Bluetooth. The inventive terminal may be used in any other location where radio coverage of a wireless local area telecommunications network exists, and where it is not permissible to allow a radio interface capable of connecting to a wireless global network to function.

1. A two-mode Mobile telephone terminal, comprising:
a first interface configured to connect to a wireless global telecommunications network;
a second interface configured to connect to a wireless local area telecommunications network (WLAN); and
a control unit operatively connected to the first and second interfaces, configured to receive from the second interface a signal indicating that a terminal is connected to the wireless local area telecommunications network, and configured to send to the first interface a control signal for disabling the radio transmission of the first interface.
